(19) United States
(12) Patent Application Publication
(10) Pub. No.: US 2012/0001516 A1
(43) Pub. Date: Jan. 5, 2012

(54) STATOR FOR ELECTRIC ROTATING MACHINE AND METHOD OF MANUFACTURING THE SAME

(75) Inventors: Tomokazu HISADA, Anjo-shi (JP); Ryosuke UTAKA, Takahama-shi (JP)

(73) Assignee: DENSO CORPORATION, Kariya-city (JP)

(21) Appl. No.: 13/173,322

(22) Filed: Jun. 30, 2011

(30) Foreign Application Priority Data
Jun. 30, 2010 (JP) 2010-149111

(51) Int. Cl. H02K 1/16

(52) U.S. Cl. 310/216.069

(57) ABSTRACT

A stator includes an annular stator core and a stator coil. In each of slots of the stator core, there are received a predetermined number of in-slot portions of the stator coil in alignment with each other in a radial direction of the stator core. Each of side surfaces of tooth portions of the stator core includes, at its radially inner end, an oblique surface that extends obliquely with respect to the radial direction. The oblique surfaces are shaped so that for each of the slots, the circumferential width of the slot is decreased in the radially inward direction in that part of the slot which is located between a corresponding pair of the oblique surfaces. For each of the slots, the in-slot portion which is located radially innermost in the slot is held at a predetermined radial position by the corresponding pair of the oblique surfaces.

### CROSS-REFERENCE TO RELATED APPLICATION

This application is based on and claims priority from Japanese Patent Application No. 2010-149111, filed on Jun. 30, 2010, the content of which is hereby incorporated by reference in its entirety into this application.

### BACKGROUND

1. Technical Field

The present invention relates to stators for electric rotating machines that are used in, for example, motor vehicles as electric motors and electric generators, and to methods of manufacturing the stators.

2. Description of Related Art

Conventionally, there are known stators for electric rotating machines which include an annular stator core and a stator coil. The stator core has a plurality of slots that are formed in the radially inner surface of the stator core and spaced from one another in the circumferential direction of the stator core. The stator coil is mounted on the stator core so as to have a plurality of in-slot portions each of which is received in a corresponding one of the slots of the stator core. Moreover, in each of the slots of the stator core, there are a predetermined number of the in-slot portions of the stator coil aligned with each other in a radial direction of the stator core.

Furthermore, to ensure high magnetic performance of the stator, it is necessary to suitably position the in-slot portions of the stator coil with respect to the stator core.

One conventional method of positioning the in-slot portions of the stator coil with respect to the stator core is to fix the in-slot portions to the stator core or to insulating paper interposed between the stator core and the stator coil by performing an impregnation process using liquid resin (e.g., epoxy resin).

However, with the above conventional method, it may be difficult to accurately position the in-slot portions of the stator coil with respect to the stator core. Consequently, the in-slot portions may be positioned radially inward from a desired position, resulting in an increase in eddy loss of the stator coil.

Japanese Patent Application Publication No. 2000-134847 discloses a method of fixing the radially innermost position of a stator coil in each of the slots of a stator core. Specifically, according to the method, the stator coil is wrapped with insulating paper and inserted into the slots of the stator core. Then, for each of the slots of the stator core, a wedge is further inserted into the slot so as to be located radially inside the stator coil, thereby fixing the radially innermost position of the stator coil in the slot. Thereafter, portions of the insulating paper which protrude outside the slot respectively on opposite axial sides of the stator core are folded back so as to make contact with the axial ends of the wedge. As a result, the axial position of the wedge is also fixed by the insulating paper.

However, with the above method, it is necessary to employ the same number of the wedges as the slots of the stator core; consequently, the manufacturing cost of the stator will be increased. Moreover, it is also necessary to wrap each of the in-slot portions of the stator coil with the insulating paper; consequently, the assembly process of the stator will be complicated.

Japanese Patent Application Publication No. 2006-187073 discloses another method of fixing the radially innermost position of a stator coil in each of the slots of a stator core. Specifically, according to the method, a plurality of insulators are employed each of which is fixed to a corresponding one of the axial end faces of tooth portions of the stator core. Further, each of the insulators has formed therein a guide groove for fixing the radially innermost position of the stator coil in a corresponding one of the slots which is circumferentially adjacent to the insulator.

However, with the above method, it is necessary to employ the insulators the number of which is twice that of the tooth portions of the stator core. Further, the structure of the insulators is complicated by formation of the grooves therein. Consequently, the manufacturing cost of the stator will be increased.

### SUMMARY

According to one aspect of the invention, there is provided a stator for an electric rotating machine. The stator includes an annular stator core and a stator coil. The stator core has a plurality of tooth portions and a plurality of slots. Each of the tooth portions radially extends so as to have a pair of side surfaces opposite to each other in the circumferential direction of the stator core. The tooth portions are spaced from one another in the circumferential direction of the stator core. Each of the slots is formed between a corresponding circumferentially-facing pair of the side surfaces of the tooth portions. The stator coil is mounted on the stator core so as to have a plurality of in-slot portions each of which is received in a corresponding one of the slots of the stator core. Furthermore, in each of the slots of the stator core, there are a predetermined number of the in-slot portions of the stator coil aligned with each other in a radial direction of the stator core. Each of the side surfaces of the tooth portions includes, at its radially inner end, an oblique surface that extends obliquely with respect to the radial direction in which the in-slot portions of the stator coil received in the slot adjacent to the side surface are aligned with each other. The oblique surfaces are shaped so that for each of the slots, the circumferential width of the slot is decreased in the radially inward direction in that part of the slot which is located between a corresponding pair of the oblique surfaces. For each of the slots, that one of the in-slot portions of the stator coil which is located radially innermost in the slot is held at a predetermined radial position by the corresponding pair of the oblique surfaces.

With the above configuration, during the mounting of the stator coil to the stator core, it is possible to easily and accurately position the radially innermost in-slot portions of the stator coil in the corresponding slots of the stator core by means of the oblique surfaces provided in the side surfaces of the tooth portions of the stator core. In other words, it is possible to easily and accurately fix the radially innermost position of the stator coil in each of the slots of the stator core, thereby facilitating the mounting of the stator coil to the stator core. Moreover, since no additional parts or devices are needed for positioning the radially innermost in-slot portions of the stator coil in the corresponding slots of the stator core, the manufacturing cost of the stator can be reduced.

In further implementations, in each of the side surfaces of the tooth portions of the stator core, the oblique surface may be provided to extend from a position between the radially outer and radially inner ends of the side surface to the radially inner end of the side surface. Further, in this case, it is preferable that the oblique surface extends from a position between the radial center and radially inner end of the side surface to the radially inner end of the side surface.

Otherwise, the oblique surface may be provided to extend from the radially outer end to the radially inner end of the side surface.

For each of the tooth portions of the stator core, there may be a pair of projections formed at a distal end of the tooth portion so as to circumferentially project respectively from the side surfaces of the tooth portion. Further, in this case, in each of the side surfaces of the tooth portions of the stator core, the oblique surface may be provided so as to adjoin a corresponding one of the projections, which circumferentially projects from the side surface, from the radially outside of the corresponding projection. Furthermore, it is preferable that the oblique surface is provided to extend, from a position substantially equidistant from the radial center of the side surface and the corresponding projection, to the corresponding projection.

According to another aspect of the invention, there is provided a method of manufacturing a stator for an electric rotating machine. The method comprising the steps of: (1) preparing an annular stator core and a plurality of electric wire segments, the stator core having a plurality of tooth portions and a plurality of slots, each of the tooth portions radially extending so as to have a pair of side surfaces opposite to each other in the circumferential direction of the stator core, the tooth portions being spaced from one another in the circumferential direction of the stator core, each of the slots being formed between a corresponding circumferentially-facing pair of the side surfaces of the tooth portions, each of the electric wire segments having a pair of straight portions that extend parallel to each other and a turn portion that connects the straight portions at ends thereof on the same side; (2) inserting the straight portions of the electric wire segments respectively into corresponding ones of the slots from one axial side of the stator core, so that distal parts of the straight portions respectively protrude from the corresponding slots on the other axial side of the stator core; and (3) joining corresponding pairs of the distal parts of the straight portions of the electric wire segments, thereby forming a stator coil. Furthermore, in the stator core prepared in the preparing step, each of the side surfaces of the tooth portions includes, at its radially inner end, an oblique surface that extends obliquely with respect to the depth-wise direction of a corresponding one of the slots which is adjacent to the side surface. The oblique surfaces are shaped so that for each of the slots, the circumferential width of the slot is decreased in a radially inward direction in that part of the slot which is located between a corresponding pair of the oblique surfaces. In the inserting step, for each of the slots of the stator core, first, second and third groups of the straight portions of the electric wire segments are inserted into the slot. The first group of the straight portions is first axially inserted into a radially center part of the slot and then moved radially inward, thereby being radially positioned by the corresponding pair of the oblique surfaces. The second group of the straight portions is first axially inserted into the radially center part of the slot and then moved radially outward, thereby being radially positioned by a bottom surface of the slot. The third group of the straight portions is axially inserted into the radially center part of the slot, thereby being radially positioned between the first and second groups of the straight portions.

With the above method, in each of the slots of the stator core, the first group of the straight portions of the electric wire segments is radially positioned by the corresponding pair of the oblique surfaces without employing any additional positioning means. Consequently, the manufacturing cost of the stator can be reduced.

### BRIEF DESCRIPTION OF THE DRAWINGS

The present invention will be understood more fully from the detailed description given hereinafter and from the accompanying drawings of preferred embodiments of the invention, which, however, should not be taken to limit the invention to the specific embodiments but are for the purpose of explanation and understanding only.

In the accompanying drawings:

FIG. 1 is a schematic, partially cross-sectional view of an electric rotating machine which includes a stator according to the first embodiment of the invention;

FIG. 2 is a perspective view of the stator from one axial side of a stator core of the stator;

FIG. 3 is a perspective view of the stator from the other axial side of the stator core;

FIG. 4 is an axial end view of part of the stator;

FIGS. 5A-5D are schematic perspective views illustrating a method of manufacturing the stator according to the first embodiment; and

FIG. 6 is an axial end view of part of a stator according to the second embodiment of the invention.

### DESCRIPTION OF PREFERRED EMBODIMENTS

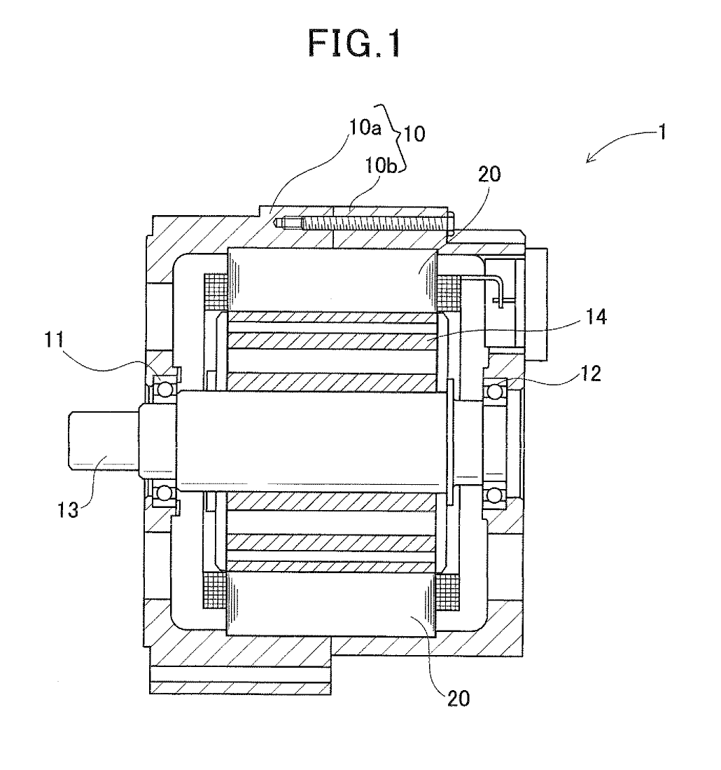

Preferred embodiments of the present invention will be described hereinafter with reference to FIGS. 1-6. It should be noted that for the sake of clarity and understanding, identical components having identical functions in different embodiments of the invention have been marked, where possible, with the same reference numerals in each of the figures and that for the sake of avoiding redundancy, descriptions of the identical components will not be repeated.

### [First Embodiment]

FIG. 1 shows the overall configuration of an electric rotating machine 1 which includes a stator 20 according to the first embodiment of the invention.

The electric rotating machine 1 is designed to be used in a motor vehicle, such as an electric vehicle or a hybrid vehicle, and can function both as an electric motor and as an electric generator.

As shown in FIG. 1, the electric rotating machine 1 further includes a housing 10 and a rotor 14 in addition to the stator 20. The housing 10 is comprised of a pair of cup-shaped housing pieces 10a and 10b which are jointed together at the open ends thereof. The housing 10 has a pair of bearings 11 and 12 mounted therein, via which a rotating shaft 13 is rotatably supported by the housing 10. The rotor 14 is received in the housing 10 and fixed on the rotating shaft 13. The stator 20 is fixed in the housing 10 so as to surround the radially outer periphery of the rotor 14.

The rotor 14 includes a plurality of permanent magnets that form a plurality of magnetic poles on the radially outer periphery of the rotor 14 to face the radially inner periphery of the stator 20. The polarities of the magnetic poles alternate between north and south in the circumferential direction of the rotor 14. The number of the magnetic poles is set according to the design specification of the electric rotating machine 1. In the present embodiment, the number of the magnetic poles is set to be equal to, for example, eight (i.e., four north poles and four south poles).

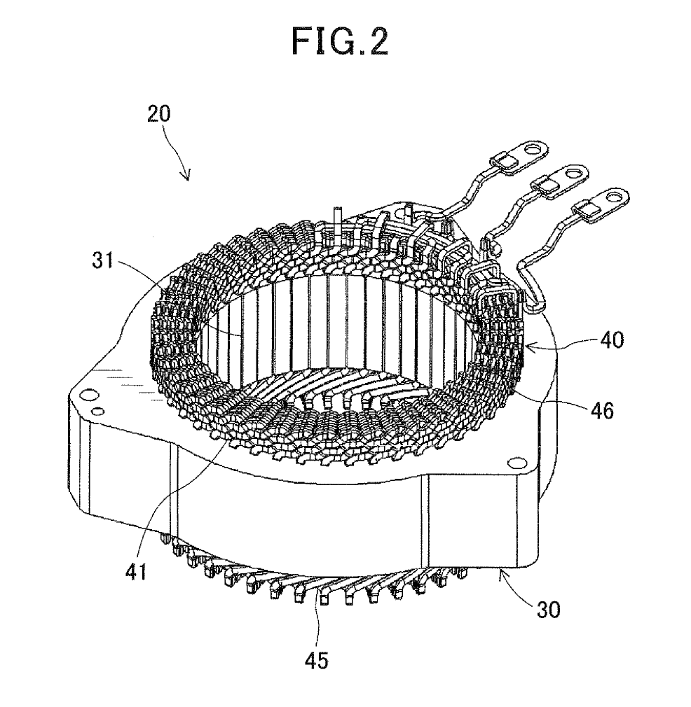

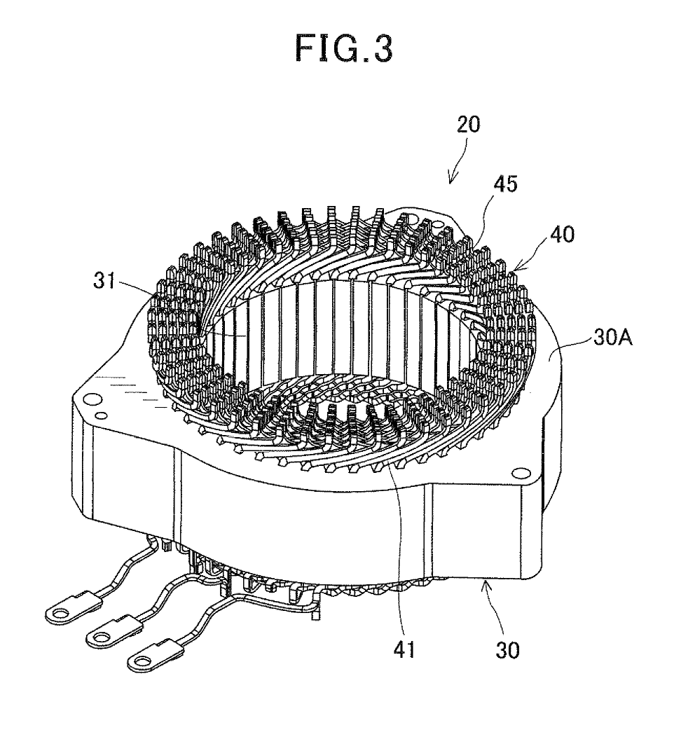

Referring now to FIGS. 2 and 3, the stator 20 includes an annular stator core 30 and a three-phase stator coil 40 mounted on the stator core 30.

The stator core 30 has a plurality of slots 31 that are formed in the radially inner surface of the stator core 30 and spaced in the circumferential direction of the stator core 30 from one another. For each of the slots 31, the depth-wise direction of the slot 31 coincides with a radial direction of the stator core 30. In the present embodiment, there are provided two slots 31 per magnetic pole of the rotor that has the eight magnetic poles and per phase of the three-phase stator coil 40. Accordingly, the total number of the slots 31 provided in the stator core 30 is equal to 48 (i.e., 2×8×3).

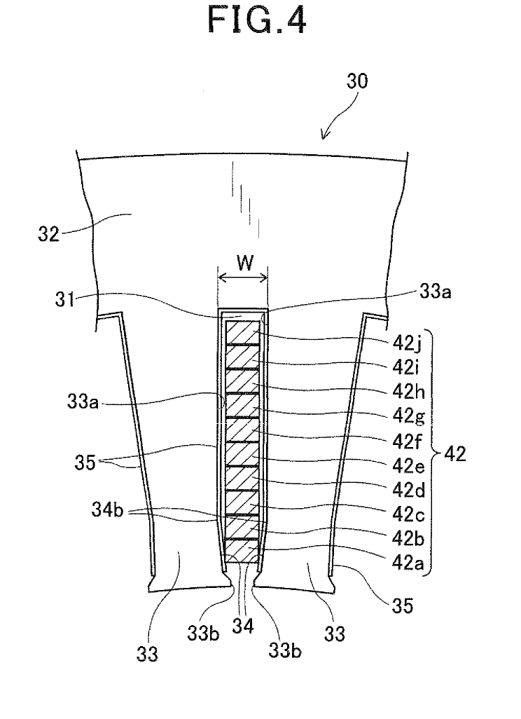

Moreover, referring further to FIG. 4, the stator core 30 has an annular back core portion 32 and a plurality of tooth portions 33 that each extend radially inward from a radially inner periphery of the back core portion 32 and are spaced in the circumferential direction of the stator core 30 from one another. Moreover, each circumferentially-adjacent pair of the tooth portions 33 (or each circumferentially-facing pair of side surfaces 33a of the tooth portions 33) together defines one of the slots 31 therebetween. Accordingly, the number of the tooth portions 33 is also equal to 48 in the present embodiment.

Furthermore, in the present embodiment, for each of the tooth portions 33, there is a pair of projections 33b formed at the distal end of the tooth portion 33 so as to circumferentially project respectively from the side surfaces 33a of the tooth portion 33.

Each of the side surfaces 33a of the tooth portions 33 includes, at its radially inner end, an oblique surface 34 that extends obliquely with respect to the depth-wise direction of a corresponding one of the slots 31 which is adjacent to the side surface 33a and adjoins a corresponding one of the projections 33b which circumferentially projects from the side surface 33a. Moreover, the oblique surfaces 34 are shaped so that for each of the slots 31, the circumferential width W of the slot 31 is gradually decreased in the radially inward direction in that part of the slot 31 which is located between a corresponding pair of the oblique surfaces 34.

In the present embodiment, in each of the side surfaces 33a of the tooth portions 33 of the stator core 30, the oblique surface 34 is provided to extend from a position between the radially outer and inner ends of the side surface 33a to the radially inner end of the side surface 33a (or to the corresponding projection 33b).

Specifically, in the present embodiment, the oblique surface 34 is provided to extend from a position between the radial center and radially inner end of the side surface 33a to the radially inner end of the side surface 33a (or to the corresponding projection 33b).

More specifically, in the present embodiment, the oblique surface 34 is provided to extend, from a position substantially equidistant from the radial center and radially inner end of the side surface 33a, to the radially inner end of the side surface 33a (or to the corresponding projection 33b).

Moreover, each circumferentially-facing pair of the side surfaces 33a of the tooth portions 33 extend parallel to each other except in those parts of the side surfaces 33a which make up the oblique surfaces 34. Consequently, for each of the slots 31, the circumferential width W of the slot 31 is constant in the radial direction except in that part of the slot 31 which is located between a corresponding pair of the oblique surfaces 34.

In addition, for each of the slots 31, there is arranged insulating paper 35 to cover both the side surfaces 33a and the bottom surface of the slot 31.

The stator coil 40 is mounted on the stator core 30 so as to have a plurality of in-slot portions 42 each of which is received in a corresponding one of the slots 31 of the stator core 30.

Moreover, as shown in FIG. 4, in each of the slots 31 of the stator core 30, there are a predetermined number (e.g., 10 in the present embodiment) of the in-slot portions 42 of the stator coil 40 aligned with each other in the radial direction of the stator core 30 which coincides with the depth-wise direction of the slot 31. In addition, for the sake of convenience of explanation, the in-slot portions 42 of the stator coil 40 received in the same slot 31 are suffixed by the letters a-j from the radially inner side.

As seen from FIG. 4, for each of the slots 31, the in-slot portion 42a of the stator coil 40 which is located radially innermost in the slot 31 is held at a predetermined radial position by the corresponding pair of the oblique surfaces 34. In other words, the radially innermost in-slot portion 42a is radially positioned by the corresponding pair of the oblique surfaces 34. Consequently, the radially innermost position of the stator coil 40 in the slot 31 is also fixed by the corresponding pair of the oblique surfaces 34.

In addition, the radial position, at which the radially innermost in-slot portion 42a of the stator coil 40 is held by the corresponding pair of the oblique surfaces 34, is predetermined based on the circumferential width W of the slot 31, the number of the in-slot portions 42 received in the slot 31, the circumferential width of the radially innermost in-slot portion 42a, and the distance from the radially innermost in-slot portion 42a to the radially inner end of the slot 31.

Moreover, for each of the slots 31, all of the in-slot portions 42a-42j of the stator coil 40 received in the slot 31 are classified into three groups. The first group consists of the in-slot portions 42a-42d; the second group consists of the in-slot portions 42g-42j; the third group consists of the in-slot portions 42e and 42f. As will be described in detail later, in mounting the stator coil 40 to the stator core 30, the in-slot portions 42a-42d of the first group are first axially inserted into a radially center part of the slot 31 and then moved radially inward to their respective rest positions. On the other hand, the in-slot portions 42g-42j of the second group are first axially inserted into the radially center part of the slot 31 and then moved radially outward to their respective rest positions. Further, the in-slot portions 42e and 42f of the third group are axially inserted into the radially center part of the slot 31 and kept thereat without being moved radially inward or outward.

In the present embodiment, the stator coil 40 is formed by first inserting a plurality of electric wire segments 41 into the slots 31 of the stator core 30 in a predetermined manner and then joining them in a predetermined pattern by welding.

Specifically, in the present embodiment, each of the electric wire segments 41 is comprised of an electric conductor segment having a substantially rectangular cross section and an insulating coat that covers the outer surface of the electric conductor segment. Moreover, each of the electric wire segments 41 is substantially U-shaped to include a pair of straight portions that extend parallel to each other and a turn portion that connects the straight portions at ends thereof on the same side. The straight portions are respectively inserted, from one axial side (i.e., the upper side in FIG. 2 and the lower side in FIG. 3) of the stator core 30, into a corresponding pair of the slots 31 of the stator core 30. Consequently, distal parts of the straight portions respectively protrude from the corresponding slots 31 of the stator core 30 on the other axial side (i.e., the lower side in FIG. 2 and the upper side in FIG. 3) of the stator core 30. Then, the distal parts of the straight portions are twisted to extend obliquely with respect to the corresponding axial end face 30A (i.e., the upper end face 30A in FIG. 3) of the stator core 30 and along the circumferential direction of the stator core 30 by π/2 in electrical angle. Thereafter, corresponding pairs of all the distal parts of the straight portions of the electric wire segments 41 are joined, for example by welding, to form the stator coil 40. As a result, those parts of the straight portions of the electric wire segments 41 which are inserted in the slots 31 of the stator core 30 respectively make up the in-slot portions 42 of the stator coil 40. The distal parts of the straight portions of the electric wire segments 41, which protrude outside the slots 31 on the other axial side of the stator core 30, together make up a first annular coil end 45 of the stator coil 40 as shown in FIG. 3. On the other hand, the turn portions of the electric wire segments 41, which protrude outside the slots 31 on the one axial side of the stator core 30, together make up a second annular coil end 46 of the stator coil 40 as shown in FIG. 2.

After having described the structure of the stator 20 according to the present embodiment, a method of manufacturing the stator 30 will be described hereinafter.

In the present embodiment, the method of manufacturing the stator 30 includes a preparing step, an inserting step and a joining step.

In the preparing step, the above-described annular stator core 30 and electric wire segments 41 are prepared.

In the inserting step, the straight portions of the electric wire segments 41 are respectively inserted, from the one axial side (i.e., the upper side in FIG. 2 and the lower side in FIG. 3) of the stator core 30, into corresponding ones of the slots 31. Consequently, the distal parts of the straight portions respectively protrude from the corresponding slots 31 of the stator core 30 on the other axial side (i.e., the lower side in FIG. 2 and the upper side in FIG. 3) of the stator core 30.

Hereinafter, for the sake of convenience of explanation, the straight portions of the electric wire segments 41 will be assigned the same reference numeral 42 as the in-slot portions of the stator coil 40. Further, for each of the slots 31, the straight portions 42 to be inserted into the slot 31 and the respective electric wire segments 41 will be suffixed by the letters a-j from the radially inner side.

In the present embodiment, for each of the slots 31 of the stator core 30, all of the straight portions 42 of the electric wire segments 41 to be inserted into the slot 31 are classified into three groups. The first group consists of the straight portions 42a-42d of the electric wire segments 41a-41d; the second group consists of the straight portions 42g-42j of the electric wire segments 41g-41j; the third group consists of the straight portions 42e and 42f of the electric wire segments 41e and 41f.

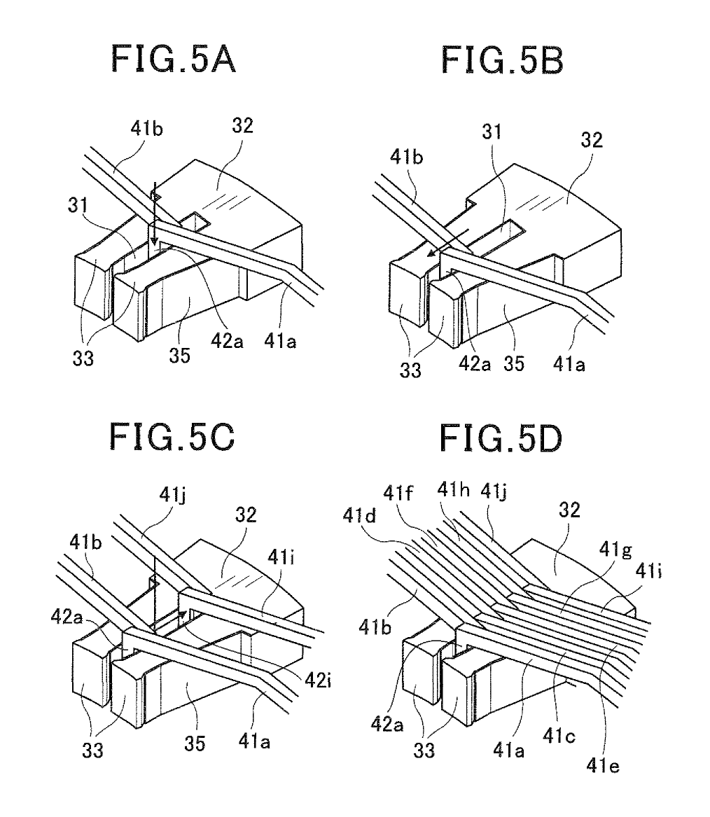

In the inserting step, for each of the slots 31 of the stator core 30, the straight portions 42a and 42b of the first group are first axially inserted into the radially center part of the slot 31, as shown in FIG. 5A. Then, the straight portions 42a and 42b are moved radially inward, as shown in FIG. 5B, until being stopped by the corresponding pair of the oblique surfaces 34 of the tooth portions 33. Consequently, the straight portions 42a and 42b are radially positioned by the corresponding pair of the oblique surfaces 34. More specifically, the straight portion 42a of the electric wire segment 41a is brought to the predetermined radial position at which it is held between the corresponding pair of the oblique surfaces 34.

Next, referring to FIG. 5C, the straight portions 42i and 42j of the second group are first axially inserted into the radially center part of the slot 31, and then moved radially outward until being stopped by the bottom surface of the slot 31. Consequently, the straight portions 42i and 42j are radially positioned by the bottom surface of the slot 31.

Further, the straight portions 42c and 42d of the first group are first axially inserted into the radially center part of the slot 31, and then moved radially inward until being stopped by the straight portion 42b of the first group which has been inserted in the slot 31. Consequently, all the straight portions 42a-42d of the first group are together radially positioned in the slot 31 by the corresponding pair of the oblique surfaces 34.

Thereafter, the straight portions 42g and 42h of the second group are first axially inserted into the radially center part of the slot 31, and then moved radially outward until being stopped by the straight portion 42i of the second group which has been inserted in the slot 31. Consequently, all the straight portions 42g-42j of the second group are together radially positioned in the slot 31 by the bottom surface of the slot 31.

Finally, referring to FIG. 5D, the straight portions 42e and 42f of the third group are axially inserted into the radially center part of the slot 31 and kept thereat without being radially moved. Consequently, the straight portions 42e and 42f of the third group are together radially positioned between the straight portion 42d of the first group and the straight portion 42g of the second group.

As a result, all of the straight portions 42a-42j of the electric wire segments 41a-41j are radially aligned in the slot 31, thereby respectively making up the in-slot portions 42a-42j of the stator coil 40 received in the slot 31.

In the joining step, corresponding pairs of all the distal parts of the straight portions 42 of the electric wire segments 41 are joined, for example by welding, forming the stator coil 40.

More specifically, in this step, the distal parts of the straight portions 42 are first twisted to extend obliquely with respect to the corresponding axial end face 30A (i.e., the upper end face 30A in FIG. 3) of the stator core 30 and along the circumferential direction of the stator core 30 by π/2 in electrical angle. Then, corresponding pairs of all the distal parts of the straight portions 42 are welded to form the stator coil 40.

In addition, in the present embodiment, the distal parts of the straight portions 42 of the electric wire segments 41 are joined so that the resultant stator coil 40 is wave-wound around the stator core 30. Moreover, for facilitating the welding process, the insulating coat is first stripped from the ends of the distal parts; after the welding process, the stripped ends are then coated with, for example, powder resin. Further, the distal parts are bent at their respective distal ends so as to secure a sufficiently long insulation distance between the welds formed therebetween.

As a result, the stator 20 is obtained which includes the annular stator core 30 and the stator coil 40 comprised of the electric wire segments 41 mounted on the stator core 30.

According to the present embodiment, it is possible to achieve the following advantages.

In the stator 20 according to the present embodiment, each of the side surfaces 33a of the tooth portions 33 of the stator core 30 includes, at its radially inner end, the oblique surface 34 that extends obliquely with respect to the radial direction in which are aligned the in-slot portions 42 of the stator coil 40 received in the slot 31 that is adjacent to the side surface 33a. Moreover, the oblique surfaces 34 are shaped so that for each of the slots 31, the circumferential width W of the slot 31 is decreased in the radially inward direction in that part of the slot 31 which is located between the corresponding pair of the oblique surfaces 34.

With the oblique surfaces 34, it is possible to easily and accurately position the radially innermost in-slot portions 42a of the stator coil 40 in the corresponding slots 31 of the stator core 30 during the mounting of the stator coil 40 to the stator core 30. In other words, it is possible to easily and accurately fix the radially innermost position of the stator coil 40 in each of the slots 31 of the stator core 30, thereby facilitating the mounting of the stator coil 40 to the stator core 30. Moreover, since no additional parts or devices are needed for positioning the radially innermost in-slot portions 42a of the stator coil 40 in the corresponding slots 31 of the stator core 30, the manufacturing cost of the stator 20 can be reduced.

Moreover, in the present embodiment, in each of the side surfaces 33a of the tooth portions 33 of the stator core 30, the oblique surface 34 is provided to extend from a position between the radially outer and radially inner ends of the side surface 33a to the radially inner end of the side surface 33a. In other words, the oblique surface 34 is provided in only part of the side surface 33a.

With the above formation of the oblique surfaces 34, during the mounting of the stator coil 40 to the stator core 30, it is possible to easily axially insert each of the straight portions 42 of the electric wire segments 41 into that part of the corresponding slot 31 of the stator core 30 which is located not between the corresponding pair of the oblique surfaces 34.

More specifically, in the present embodiment, in each of the side surfaces 33a of the tooth portions 33 of the stator core 30, the oblique surface 34 is provided to extend from a position between the radial center and radially inner end of the side surface 33a to the radially inner end of the side surface 33a. In other words, the oblique surface 34 is located radially inward from the radial center of the side surface 33a.

With the above formation of the oblique surfaces 34, during the mounting of the stator coil 40 to the stator core 30, it is possible to easily axially insert each of the straight portions 42 of the electric wire segments 41 into the radially center part of the corresponding slot 31 which is formed not between the corresponding pair of the oblique surfaces 34.

In the present embodiment, the stator coil 40 is comprised of the electric wire segments 41. Consequently, compared to the case of forming a stator coil by winding long electric wires around a stator core, the length of each of the electric wire segments 41 can be reduced. As a result, the electric wire segments 42 can be easily handled, thereby facilitating the process of mounting the stator coil 40 to the stator core 30.

Further, in the inserting step in manufacturing the stator 20, for each of the slots 31 of the stator core 30, the straight portions 42a-42d of the electric wire segments 41a-41d (i.e., the first group of the straight portions 42) are first axially inserted into the radially center part of the slot 31 and then moved radially inward. In the present embodiment, since there are the oblique surfaces 34 provided in the side surfaces 33a of the tooth portions 33 of the stator core 30, the radially inward movement of the radially innermost in-slot portions 42a in the corresponding slots 31 is stopped by the corresponding pair of the oblique surfaces 34. Consequently, the radially innermost in-slot portions 42a are radially positioned in the corresponding slots 31 without employing any additional positioning means. As a result, it is possible to reduce the manufacturing cost of the stator 20.

### [Second Embodiment]

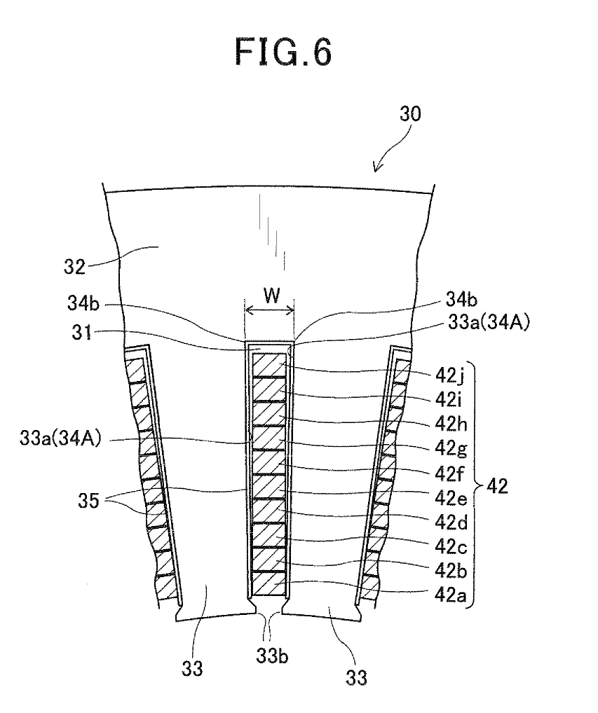

Referring to FIG. 6, in this embodiment, in each of the side surfaces 33a of the tooth portions 33 of the stator core 30, the oblique surface 34A is provided to extend from the radially outer end to the radially inner end of the side surface 33a. In other words, the oblique surface 34A is provided to extend over the entire radial length of the side surface 33a.

Consequently, in this embodiment, for each of the slots 31 of the stator core 30, the circumferential width W of the slot 31 is gradually decreased in the radially inward direction from the bottom surface of the slot 31 to the corresponding pair of the projections 33b.

Moreover, as in the first embodiment, in each of the slots 31 of the stator core 30, there are ten in-slot portions 42a-42j of the stator coil 40 aligned with each other in the radial direction of the stator core 30 which coincides with the depth-wise direction of the slot 31. Further, the radially innermost in-slot portion 42a is held at a predetermined radial position by the corresponding pair of the oblique surfaces 34A. In other words, the radially innermost in-slot portion 42a is radially positioned by the corresponding pair of the oblique surfaces 34. Consequently, the radially innermost position of the stator coil 40 in the slot 31 is also fixed by the corresponding pair of the oblique surfaces 34.

With the above configuration of the stator 20 according to the present embodiment, it is possible to achieve the same advantages as with that according to the first embodiment.

Moreover, in the present embodiment, in each of the side surfaces 33a of the tooth portions 33 of the stator core 30, the oblique surface 34A is provided to extend over the entire radial length of the side surface 33a. Consequently, the circumferential width of each of the tooth portions 33 of the stator core 30 is prevented from being rapidly changed due to formation of the oblique surfaces 34A. As a result, it is possible to prevent magnetic saturation of the tooth portions 33 from occurring, thereby suppressing iron loss of the stator core 30. In addition, it is also possible to improve the space factors of the in-slot portions 42 of the stator coil 40 in the slots 31 of the stator core 30 in comparison with the first embodiment.

While the above particular embodiments of the present invention have been shown and described, it will be understood by those skilled in the art that various modifications, changes, and improvements may be made without departing from the spirit of the invention.

For example, in the previous embodiments, the number of the in-slot portions 42 of the stator coil 40 received in each of the slots 31 of the stator core 30 is equal to 10. However, the number of the in-slot portions 42 received in each of the slots 31 may be suitably changed according to the number of phases of the stator coil 40 and the number of magnetic poles of the rotor 14.

Moreover, in the previous embodiments, the distal parts of the straight portions 42 of the electric wire segments 41 are joined so that the resultant stator coil 40 is wave-wound around the stator core 30. However, the distal parts of the straight portions 42 may also be joined so that the resultant stator coil 40 is lap-wound around the stator core 30.

What is claimed is:

1. A stator for an electric rotating machine, the stator comprising:
an annular stator core that has a plurality of tooth portions and a plurality of slots, each of the tooth portions radially extending so as to have a pair of side surfaces opposite to each other in a circumferential direction of the stator core, the tooth portions being spaced from one another in the circumferential direction of the stator core, each of the slots being formed between a corresponding circumferentially-facing pair of the side surfaces of the tooth portions; and
a stator coil that is mounted on the stator core so as to have a plurality of in-slot portions each of which is received in a corresponding one of the slots of the stator core,
wherein
in each of the slots of the stator core, there are a predetermined number of the in-slot portions of the stator coil aligned with each other in a radial direction of the stator core,
each of the side surfaces of the tooth portions includes, at its radially inner end, an oblique surface that extends obliquely with respect to the radial direction in which the in-slot portions of the stator coil received in the slot adjacent to the side surface are aligned with each other;
the oblique surfaces are shaped so that for each of the slots, the circumferential width of the slot is decreased in a radially inward direction in that part of the slot which is located between a corresponding pair of the oblique surfaces, and
for each of the slots, that one of the in-slot portions of the stator coil which is located radially innermost in the slot is held at a predetermined radial position by the corresponding pair of the oblique surfaces.

2. The stator as set forth in claim 1, wherein in each of the side surfaces of the tooth portions of the stator core, the oblique surface is provided to extend from a position between the radially outer and radially inner ends of the side surface to the radially inner end of the side surface.

3. The stator as set forth in claim 2, wherein in each of the side surfaces of the tooth portions of the stator core, the oblique surface is provided to extend from a position between the radial center and radially inner end of the side surface to the radially inner end of the side surface.

4. The stator as set forth in claim 1, wherein in each of the side surfaces of the tooth portions of the stator core, the oblique surface is provided to extend from the radially outer end to the radially inner end of the side surface.

5. The stator as set forth in claim 1, wherein for each of the tooth portions of the stator core, there are a pair of projections formed at a distal end of the tooth portion so as to circumferentially project respectively from the side surfaces of the tooth portion.

6. The stator as set forth in claim 5, wherein in each of the side surfaces of the tooth portions of the stator core, the oblique surface is provided so as to adjoin a corresponding one of the projections, which circumferentially projects from the side surface, from the radially outside of the corresponding projection.

7. The stator as set forth in claim 6, wherein in each of the side surfaces of the tooth portions of the stator core, the oblique surface is provided to extend, from a position substantially equidistant from the radial center of the side surface and the corresponding projection, to the corresponding projection.

8. A method of manufacturing a stator for an electric rotating machine, the method comprising the steps of:
preparing an annular stator core and a plurality of electric wire segments, the stator core having a plurality of tooth portions and a plurality of slots, each of the tooth portions radially extending so as to have a pair of side surfaces opposite to each other in a circumferential direction of the stator core, the tooth portions being spaced from one another in the circumferential direction of the stator core, each of the slots being formed between a corresponding circumferentially-facing pair of the side surfaces of the tooth portions, each of the electric wire segments having a pair of straight portions that extend parallel to each other and a turn portion that connects the straight portions at ends thereof on the same side;
inserting the straight portions of the electric wire segments respectively into corresponding ones of the slots from one axial side of the stator core, so that distal parts of the straight portions respectively protrude from the corresponding slots on the other axial side of the stator core; and
joining corresponding pairs of the distal parts of the straight portions of the electric wire segments, thereby forming a stator coil,
wherein
in the stator core prepared in the preparing step, each of the side surfaces of the tooth portions includes, at its radially inner end, an oblique surface that extends obliquely with respect to the depth-wise direction of a corresponding one of the slots which is adjacent to the side surface,
the oblique surfaces are shaped so that for each of the slots, the circumferential width of the slot is decreased in a radially inward direction in that part of the slot which is located between a corresponding pair of the oblique surfaces,
in the inserting step, for each of the slots of the stator core, first, second and third groups of the straight portions of the electric wire segments are inserted into the slot,
the first group of the straight portions is first axially inserted into a radially center part of the slot and then moved radially inward, thereby being radially positioned by the corresponding pair of the oblique surfaces,
the second group of the straight portions is first axially inserted into the radially center part of the slot and then moved radially outward, thereby being radially positioned by a bottom surface of the slot, and
the third group of the straight portions is axially inserted into the radially center part of the slot, thereby being radially positioned between the first and second groups of the straight portions.

9. The method as set forth in claim 8, wherein in each of the side surfaces of the tooth portions of the stator core, the oblique surface is provided to extend from a position between the radially outer and radially inner ends of the side surface to the radially inner end of the side surface.

10. The method as set forth in claim 9, wherein in each of the side surfaces of the tooth portions of the stator core, the oblique surface is provided to extend from a position between the radial center and radially inner end of the side surface to the radially inner end of the side surface.

11. The method as set forth in claim 8, wherein in each of the side surfaces of the tooth portions of the stator core, the oblique surface is provided to extend from the radially outer end to the radially inner end of the side surface.

12. The method as set forth in claim 8, wherein for each of the tooth portions of the stator core, there are a pair of projections formed at a distal end of the tooth portion so as to circumferentially project respectively from the side surfaces of the tooth portion.

13. The method as set forth in claim 12, wherein in each of the side surfaces of the tooth portions of the stator core, the oblique surface is provided so as to adjoin a corresponding one of the projections, which circumferentially projects from the side surface, from the radially outside of the corresponding projection.

14. The method as set forth in claim 13, wherein in each of the side surfaces of the tooth portions of the stator core, the oblique surface is provided to extend, from a position substantially equidistant from the radial center of the side surface and the corresponding projection, to the corresponding projection.
